(19) United States
(12) Patent Application Publication
(10) Pub. No.: US 2012/0081089 A1
(43) Pub. Date: Apr. 5, 2012

(54) POWER SUPPLY CIRCUIT

(75) Inventor: Takuro Ohmaru, Zama (JP)

(73) Assignee: SEMICONDUCTOR ENERGY LABORATORY CO., LTD., Kanagawa-ken (JP)

(21) Appl. No.: 13/230,911

(22) Filed: Sep. 13, 2011

(30) Foreign Application Priority Data
Sep. 30, 2010 (JP) 2010-221615

(51) Int. Cl. G05F 1/00

(52) U.S. Cl. 323/282

(57) ABSTRACT

A power supply circuit includes: an analog/digital converter for converting an analog signal to a digital signal; a pulse width modulation signal control circuit for generating a setting control signal varying in accordance with the difference between a reference voltage and a feedback voltage and a control signal for controlling a pulse width modulation signal, which is based on the digital signal; and a pulse width modulation signal generation circuit for generating the pulse width modulation signal, to which the count signal and the control signal are input, in which the control signal controls the duty cycle of the pulse width modulation signal, and the setting control signal controls the cycle of updating the duty cycle of the pulse width modulation signal.

### BACKGROUND OF THE INVENTION

1. Field of the Invention

One embodiment of the disclosed invention relates to a power supply circuit.

2. Description of the Related Art

Conventionally, power supply circuits such as a switching regulator have been used for a wide range of electronic appliances typified by an image capturing device and a display device. Portable information terminals such as a cellular phone or a game machine have a power supply circuit incorporated therein.

This type of power supply circuit includes a digital control circuit or an analog control circuit for controlling a voltage converter circuit. The digital control circuit for use in the power supply circuit can have fewer components than the analog control circuit, thereby allowing reduction in size (see Patent Document 1).

### REFERENCE

[Patent Document 1] Japanese Published Patent Application No. 10-14234

### SUMMARY OF THE INVENTION

However, in a digital control circuit, internal operation of the digital control circuit is delayed because the digital control circuit is operated with clock signals and discontinuous data is controlled. Therefore, in the digital control circuit, the error in output signal will be increased in response to rapid changes in input signal. This increased error produces the problem of ripple caused at the output voltage of the power supply circuit.

The ripple caused at the output voltage of the power supply circuit will result in longer rising time for the output voltage of the power supply circuit.

In view of the problems described above, an object of one embodiment of the disclosed invention is to suppress generation of ripple at the output voltage of a power supply circuit.

In addition, an object of one embodiment of the disclosed invention is to suppress generation of ripple at the output voltage of a power supply circuit, thereby reducing the rising time of an output voltage from the power supply circuit.

A PWM signal control circuit for controlling the cycle of updating a signal for setting the duty cycle of a pulse width modulation (PWM) signal is provided to control a frequency response of a power supply circuit.

The method for controlling a frequency response of a power supply circuit will be described more specifically. In one embodiment of the disclosed invention, the PWM signal control circuit included in the power supply circuit controls the cycle of updating a signal for setting the duty cycle of the pulse width modulation signal.

Controlling a frequency response refers to controlling a cycle for controlling data. When the cycle for controlling data is shorter, data can be obtained for control frequently. When the cycle for controlling data is longer, data is obtained for control less frequently.

The shorter cycle increases the frequency, whereas the longer cycle decreases the frequency. Accordingly, changing the cycle corresponds to controlling the frequency.

In one embodiment of the disclosed invention, when the output voltage varies greatly, the cycle is made shorter (the frequency is made higher) for control to obtain data frequently. On the other hand, when the output voltage varies little, the cycle is made longer (the frequency is made lower) for control to obtain data less frequently.

One embodiment of the disclosed invention relates to a power supply circuit including: an analog/digital converter for converting an analog signal to a digital signal; a pulse width modulation signal control circuit for generating a setting control signal varying in accordance with a difference between a reference voltage and an output voltage and a control signal for controlling a pulse width modulation signal, which is based on the digital signal; and a pulse width modulation signal generation circuit for generating the pulse width modulation signal, to which the setting control signal and the control signal are input, wherein the control signal controls a duty cycle of the pulse width modulation signal, and the setting control signal controls a cycle of updating the duty cycle of the pulse width modulation signal.

One embodiment of the disclosed invention relates to a power supply circuit including: a voltage converter circuit; and a control circuit to which part of an output voltage of the voltage converter circuit is input, in which the control circuit includes: an analog/digital converter for converting an analog signal which is part of an output voltage of the voltage converter circuit, to a digital signal; a pulse width modulation signal control circuit for generating a setting control signal varying in accordance with a difference between a reference voltage and the output voltage and a control signal for controlling a pulse width modulation signal, which is based on the digital signal; and a pulse width modulation signal generation circuit for generating the pulse width modulation signal, to which the setting control signal and the control signal are input, wherein the control signal controls a duty cycle of the pulse width modulation signal, and the setting control signal controls a cycle of updating the duty cycle of the pulse width modulation signal.

According to one embodiment of the disclosed invention, generation of ripple at the output voltage of a power supply circuit can be suppressed.

In addition, according to one embodiment of the disclosed invention, the rising time of an output voltage from the power supply circuit can be reduced.

### BRIEF DESCRIPTION OF THE DRAWINGS

FIG. 1 is a circuit diagram of a power supply circuit;

FIG. 2 is a flowchart showing a process of setting a setting control signal; and

FIGS. 3A and 3B are graphs for comparing the rising time of a feedback voltage V_{FB} respectively in the case of varying the updating cycle and in the case of not varying the updating cycle.

### DETAILED DESCRIPTION OF THE INVENTION

Embodiments of the invention disclosed will be described below with reference to the drawings. It is to be noted that the invention is not limited to the following description, and those skilled in the art can easily understand that modes and details of the invention can be changed in various ways without departing from the spirit and the scope of the invention. Therefore, it should be noted that the present invention is not to be considered interpreted as being limited to the following description of the embodiments.

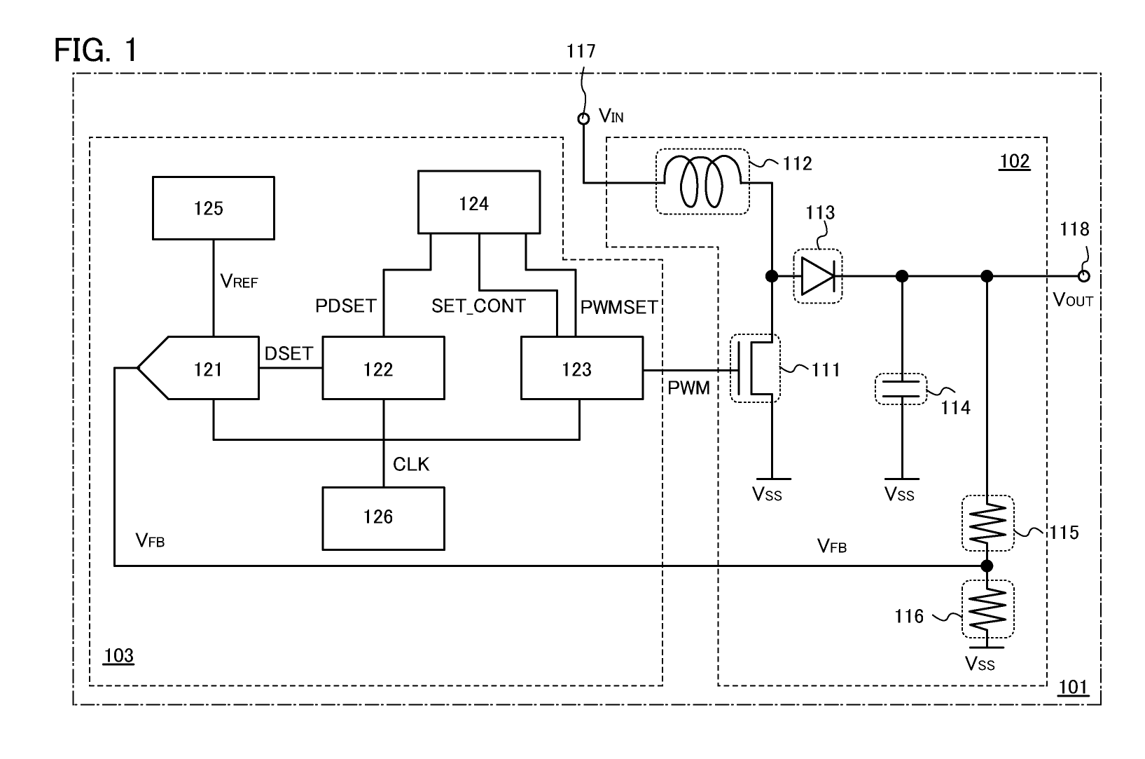

FIG. 1 shows an example of the configuration of a power supply circuit 101.

The power supply circuit 101 includes a voltage converter circuit 102, a digital control circuit 103 for controlling the voltage converter circuit 102, a terminal 117 to which a power supply voltage V_{IN} is input, and a terminal 118 to which an output voltage V_{OUT} is output. The voltage converter circuit 102 according to the present embodiment is a DC-DC converter including a transistor 111, a coil 112, a diode 113, a capacitor 114, a resistor 115, and a resistor 116.

The DC-DC converter refers to a circuit which converts a direct-current voltage to another direct-current voltage. Typical conversion modes of a DC-DC converter include a linear mode and a switching mode, and a switching mode DC-DC converter is excellent in terms of conversion efficiency. In the present embodiment, a switching mode DC-DC converter, particularly a chopper-type DC-DC converter including a transistor, a coil, a diode, and a capacitor is used as the voltage converter circuit 102.

The digital control circuit 103 includes an analog/digital (A/D) converter circuit 121, a digital filter circuit 122, a PWM signal generation circuit 123, a PWM signal control circuit 124, a reference voltage generation circuit 125 for generating a reference voltage V_{REF}, and a clock generation circuit 126 for generating a clock signal CLK.

On the basis of the ratio between the resistance values of the resistor 115 and the resistor 116, a feedback voltage V_{FB} which is a fraction of the output voltage V_{OUT} is generated from the output voltage V_{OUT} of the voltage converter circuit 102. When the resistance values of the resistor 115 and the resistor 116 are respectively represented by a resistance value R1 and a resistance value R2, the feedback voltage V_{FB} is equal to R2/(R1+R2)×V_{OUT}. The feedback voltage V_{FB} is input to the A/D converter circuit 121. In addition, a pulse width modulation signal PWM as an output signal of the PWM signal generation circuit 123 is input to a gate of the transistor 111.

The A/D converter circuit 121 converts the feedback voltage V_{FB} from the voltage converter circuit 102 to a digital signal DSET, on the basis of the reference voltage V_{REF} from the reference voltage generation circuit 125.

The digital filter circuit 122 smoothes the digital signal DSET output from the A/D converter circuit 121. Furthermore, a digital signal PDSET obtained by smoothing the digital signal DSET is output to the PWM signal control circuit 124.

It is to be noted that there may be no need to provide the digital filter circuit 122, when the feedback voltage V_{FB} is smoothed by controlling the cycle of updating the duty cycle of the pulse width modulation signal PWM as will be described. When the digital filter circuit 122 is not provided, the digital signal DSET output from the A/D converter circuit 121 is output to the PWM signal control circuit 124.

The PWM signal control circuit 124 generates a control signal PWMSET for controlling the duty cycle of the pulse width modulation signal PWM from the digital signal PDSET output from the digital filter circuit 122. The control signal PWMSET is output to the PWM signal generation circuit 123.

Further, when the digital filter circuit 122 is not provided, the control signal PWMSET for controlling the duty cycle of the pulse width modulation signal PWM is generated from the digital signal DSET.

In addition, the PWM signal control circuit 124 generates a setting control signal SET_CONT, and outputs the setting control signal SET_CONT to the PWM signal generation circuit 123.

In the PWM signal generation circuit 123, the duty cycle of the pulse width modulation signal PWM is controlled in accordance with the control signal PWMSET output from the PWM signal control circuit 124. In addition, in the PWM signal generation circuit 123, the updating cycle for setting the duty cycle of the pulse width modulation signal PWM is controlled in accordance with the setting control signal SET_CONT output from the PWM signal control circuit 124.

In the PWM signal generation circuit 123, when the digital value of the digital signal PDSET is negative, the duty cycle of the pulse width modulation signal PWM is increased.

In the PWM signal generation circuit 123, when the digital value of the digital signal PDSET is positive, the duty cycle of the pulse width modulation signal is decreased.

The frequency response of the power supply circuit 101 is determined by the frequency Fp of the pulse width modulation signal PWM, the cutoff frequency Fe of the voltage converter circuit 102, the sampling frequency Fs of the A/D converter circuit 121, the cutoff frequency Fd of the digital filter circuit 122, and the frequency Fr of updating the duty cycle of the pulse width modulation signal PWM.

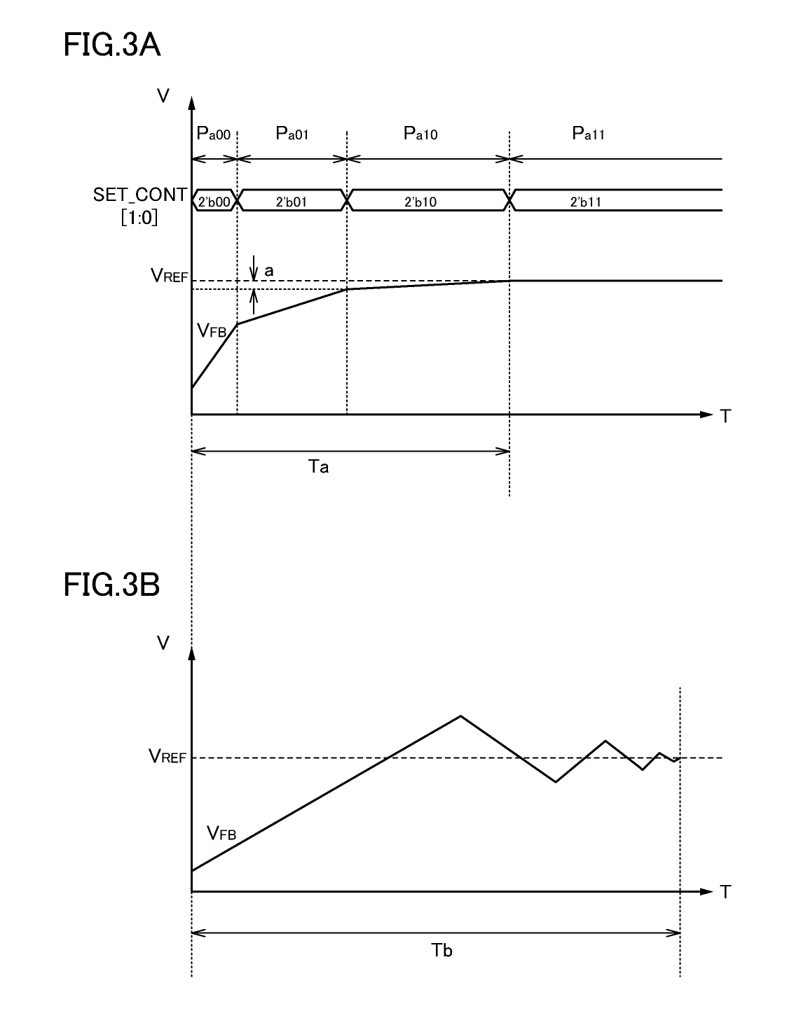

The power supply circuit 101 according to the present embodiment is configured to determine the frequency response by the internal parameter of the digital control circuit 103 (the frequency Fr of updating the duty cycle of the pulse width modulation signal PWM), independently of the cutoff frequency Fe of the voltage converter circuit 102, by setting the frequency of updating the duty cycle of the pulse width modulation signal PWM to be lowest. It is to be noted that the lowest frequency of updating the duty cycle of the pulse width modulation signal PWM, that is, the longest cycle of updating the pulse width modulation signal PWM, is specifically equal to the longest cycle of the setting control signal SET_CONT [1:0]=2′b11 (see FIG. 3A)

The cutoff frequency Fe of the voltage converter circuit 102 is represented by the following formula 1 with the inductance L of the coil 112 and the capacitance C of the capacitor 114.

$$Fe = \frac{1}{2 π \sqrt{LC}} \qquad [ Formula 1 ]$$

The frequency Fp of the pulse width modulation signal PWM is represented by the following formula 2 with the frequency Fc of an internal clock CLK from the digital control circuit 103 and a bit number N for the accuracy of controlling the duty cycle of the pulse width modulation signal PWM (provided that N is an integer).

$$Fp = \frac{Fc}{{2}^{N}} \qquad [ Formula 2 ]$$

The cutoff frequency Fe of the voltage converter circuit 102 is controlled to be lower than the frequency Fp of the pulse width modulation signal PWM, thereby allowing for the achievement of voltage conversion control in accordance with the pulse width modulation signal PWM.

The sampling frequency Fs of the A/D converter circuit 121 is represented by the following formula 3 with the frequency Fc of an internal clock signal CLK from the digital control circuit 103 (provided that M is an integer).

$$Fs = \frac{Fc}{M} \qquad [ Formula 3 ]$$

The cutoff frequency Fd of the digital filter circuit 122 is set to be lower than the sampling frequency Fs of the A/D converter circuit 121 and higher than the frequency Fr of updating the duty cycle of the pulse width modulation signal PWM.

When the frequency response is compared among the respective circuits in the power supply circuit 101, the relationships among the frequencies are represented by the following formulas 4 and 5.

Fr<Fd<Fs [Formula 4]

Fe<Fp [Formula 5]

The cutoff frequency Fe of the voltage converter circuit 102 is made sufficiently slower than the frequency Fr of updating the duty cycle of the pulse width modulation signal PWM, thereby allowing the frequency response of the power supply circuit 101 to be determined by the frequency Fr of updating the duty cycle of the pulse width modulation signal PWM. More specifically, the frequency response of the power supply circuit 101 can be determined by controlling the frequency Fr of updating the duty cycle of the pulse width modulation signal PWM.

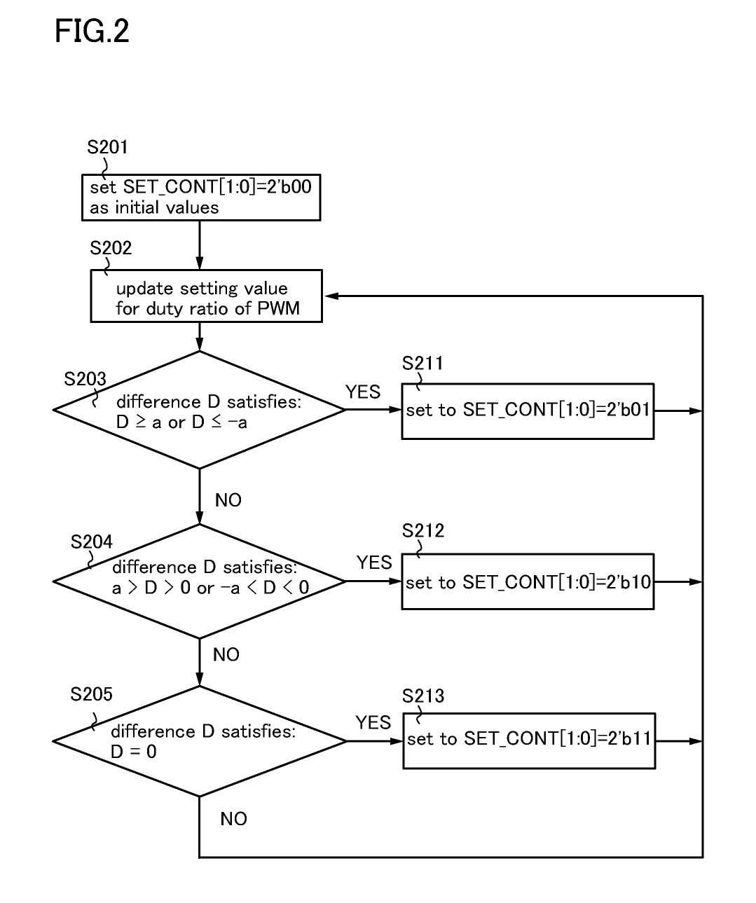

FIG. 2 is a flowchart showing a process of setting the value of the setting control signal SET_CONT generated by the PWM signal control circuit 124. More specifically, FIG. 2 is a flowchart showing how to vary the setting control signal SET_CONT [1:0] in accordance with the relationship between the digital value of any voltage a and the difference D between the digital value of the reference voltage V_{REF} and the digital value of the feedback voltage V_{FB} (the difference D corresponds to the digital signal DSET or the digital signal PDSET in FIG. 1).

First, a setting control signal SET_CONT [1] and a setting control signal SET_CONT [0] are respectively set to initial values “0” and “0” (denoted by “SET_CONT [1:0]=2′b00”) (S201).

It is to be noted that the SET_CONT [1:0] means SET_CONT [1] and SET_CONT [0]. In addition, as for the “2′b00”, the “2′” indicates the number of signals (two signals), the “b” indicates bits (binary numbers), and the “00” indicates the respective values of the setting control signal SET_CONT [1:0].

More specifically, the “SET_CONT [1:0]=2′b00” expresses two signals of the setting control signal SET_CONT [1] and the setting control signal SET_CONT [0] in binary, and indicates the values “0” and “0” of the respective signals.

Next, the state is held until the cycle of updating the duty cycle of the pulse width modulation signal PWM. On reaching the updating cycle, the setting value for the duty cycle of the pulse width modulation signal PWM is updated in accordance with the control signal PWMSET (S202).

Next, the difference D between the digital value of the reference voltage V_{REF} and the digital value of the feedback voltage V_{FB} is detected. Furthermore, The difference D is compared with the digital value of any voltage a, and in the case where D is equal to or larger than a (D≧a) or D is equal to or smaller than −a (D≦−a) (S203), the setting control signal SET_CONT [1:0] is set to 2′b01 (SET_CONT [1:0]=2′b01) (S211).

In the case of D more than 0 and less than a (a>D>0), or D less than 0 and more than −a (−a<D<0) (S204), the setting control signal SET_CONT [1:0] is set to 2′b01 (SET_CONT [1:0]=2′b10) (S212).

In the case of D equal to zero, that is, in the case where there is no difference between the digital value of the reference voltage V_{REF} and the digital value of the feedback voltage V_{FB} (D=0) (S205), the setting control signal SET_CONT [1:0] is set to 2′b11 (SET_CONT [1:0]=2′b11) (S213).

Then, the state is held until the cycle of updating the duty cycle of the pulse width modulation signal PWM.

On reaching the next cycle of updating the duty cycle of the pulse width modulation signal PWM, the setting value is updated for the duty cycle of the PWM signal (S202).

The larger value of the setting control signal SET_CONT, the slower the updating cycle.

FIGS. 3A and 3B show graphs for comparing the rising time of the feedback voltage V_{FB} respectively in the case of varying the updating cycle and in the case of not varying the updating cycle. In FIGS. 3A and 3B, the horizontal axis indicates time, whereas the vertical axis indicates a voltage value of the feedback voltage V_{FB}.

In FIG. 3A, the updating cycle is varied based on the setting control signal SET_CONT [1:0] in accordance with the flowchart in FIG. 2. On the other hand, in FIG. 3B, the updating cycle is independent of the setting control signal SET_CONT [1:0] and not varied to be constant.

As shown in FIG. 2, the setting control signal SET_CONT [1:0] varies depending on the relationship between the digital value of any voltage a and the difference D between the digital value of the reference voltage V_{REF} and the digital value of the feedback voltage V_{FB}. The variation in the setting control signal SET_CONT [1:0] is as shown in FIG. 3A.

In FIG. 3A, the updating cycle is set to Pa00 when the setting control signal SET_CONT [1:0] is 2′b00, the updating cycle is set to Pa01 when the setting control signal SET_CONT [1:0] is 2′b01, the updating cycle is set to Pa10 when the setting control signal SET_CONT [1:0] is 2′b10, and the updating cycle is set to Pa11 when the setting control signal SET_CONT [1:0] is 2′b11. The updating cycle Pa00, the updating cycle Pa01, the updating cycle Pa10, and the updating cycle Pa11 have different values respectively.

As shown in FIG. 3A, in the case of varying the cycle of the setting control signal SET_CONT [1:0], the updating cycle is controlled so as to be longer as the feedback voltage V_{FB} is closer to the reference voltage V_{REF}. Therefore, the feedback voltage V_{FB} gradually becomes equal to the reference voltage V_{RFE}, and no ripple is thus caused.

As described above, the feedback voltage V_{FB} refers to a fraction of the output voltage V_{OUT} on the basis of the ratio between the resistance values of the resistor 115 and the resistor 116. Therefore, the output voltage V_{OUT} also has no ripple caused, because the feedback voltage V_{FB} has no ripple caused.

FIG. 3B is a case of setting the updating cycle to be constant independently of the setting control signal SET_CONT [1:0].

As shown in FIG. 3B, in the case of not varying the updating cycle independently of the setting control signal SET_CONT [1:0], the updating cycle is not varied in accordance with the difference between the reference voltage V_{REF} and the feedback voltage V_{FB}, and ripple is thus caused.

When FIG. 3A is compared with FIG. 3B, the rising time Ta of the feedback voltage V_{FB} shown in FIG. 3A is shorter than the rising time Tb of the feedback voltage V_{FB} shown in FIG. 3B.

As described above, the feedback voltage V_{FB} refers to a fraction of the output voltage V_{OUT} on the basis of the ratio between the resistance values of the resistor 115 and the resistor 116. Therefore, the shortened rising time of the feedback voltage V_{FB} shortens the rising time of the output voltage V_{OUT}.

According to the embodiment described above, generation of ripple can be suppressed at the output voltage from the power supply circuit.

In addition, according to the embodiment described above, the rising time of the output voltage from the power supply circuit can be reduced.

This application is based on Japanese Patent Application serial no. 2010-221615 filed with Japan Patent Office on Sep. 30, 2010, the entire contents of which are hereby incorporated by reference.

What is claimed is:

1. A power supply circuit comprising:
a voltage converter circuit;
a pulse width modulation signal generation circuit for generating a pulse width modulation signal to control the voltage converter circuit;
an A/D converter circuit configured to convert a feedback voltage of the voltage converter circuit into a digital signal; and
a pulse width modulation signal control circuit for generating a first control signal to control a duty cycle of the pulse width modulation signal and a second control signal to control an updating cycle of the duty cycle of the pulse width modulation signal in accordance with the digital signal.

2. The power supply circuit according to claim 1, further comprising a reference voltage generation circuit configured to generate a reference voltage,
wherein the A/D converter circuit is configured to generate the digital signal in accordance with a difference between the feedback voltage of the voltage converter circuit and the reference voltage.

3. The power supply circuit according to claim 2, wherein the updating cycle in a case where the difference is smaller than a predetermined value, is set to be longer than that in a case where the difference is larger than the predetermined value.

4. The power supply circuit according to claim 1,
wherein the pulse width modulation signal generation circuit is configured to increase a duty cycle of the pulse width modulation signal when a value of the digital signal is negative, and
wherein the pulse width modulation signal generation circuit is configured to decrease a duty cycle of the pulse width modulation signal when a value of the digital signal is positive.

5. A power supply circuit comprising:
a voltage converter circuit;
a pulse width modulation signal generation circuit for generating a pulse width modulation signal to control the voltage converter circuit;
an A/D converter circuit configured to convert a feedback voltage of the voltage converter circuit into a digital signal;
a digital filter circuit configured to smooth the digital signal to generate a smoothed digital signal; and
a pulse width modulation signal control circuit for generating a first control signal to control a duty cycle of the pulse width modulation signal and a second control signal to control an updating cycle of the duty cycle of the pulse width modulation signal in accordance with the smoothed digital signal.

6. The power supply circuit according to claim 5, further comprising a reference voltage generation circuit configured to generate a reference voltage,
wherein the A/D converter circuit is configured to generate the digital signal in accordance with a difference between the feedback voltage of the voltage converter circuit and the reference voltage.

7. The power supply circuit according to claim 6, wherein the updating cycle in a case where the difference is smaller than a predetermined value, is set to be longer than that in a case where the difference is larger than the predetermined value.

8. The power supply circuit according to claim 5,
wherein the pulse width modulation signal generation circuit is configured to increase a duty cycle of the pulse width modulation signal when a value of the digital signal is negative, and
wherein the pulse width modulation signal generation circuit is configured to decrease a duty cycle of the pulse width modulation signal when a value of the digital signal is positive.

9. A power supply circuit comprising:
a voltage converter circuit comprising:
an input terminal;
a coil electrically connected to the input terminal;
a diode, wherein one terminal of the diode is electrically connected to the coil;
a transistor, wherein one terminal of the transistor is electrically connected to the coil and the one terminal of the diode; and
an output terminal electrically connected to the other terminal of the diode;
a pulse width modulation signal generation circuit for generating a pulse width modulation signal to control the voltage converter circuit, wherein the pulse width modulation signal generation circuit is electrically connected to a gate of the transistor;
an A/D converter circuit configured to convert a feedback voltage of the voltage converter circuit into a digital signal;
a digital filter circuit configured to smooth the digital signal to generate a smoothed digital signal; and
a pulse width modulation signal control circuit for generating a first control signal to control a duty cycle of the pulse width modulation signal and a second control signal to control an updating cycle of the duty cycle of the pulse width modulation signal in accordance with the smoothed digital signal.

10. The power supply circuit according to claim 9, further comprising a reference voltage generation circuit configured to generate a reference voltage,
wherein the A/D converter circuit is configured to generate the digital signal in accordance with a difference between the feedback voltage of the voltage converter circuit and the reference voltage.

11. The power supply circuit according to claim 10, wherein the updating cycle in a case where the difference is smaller than a predetermined value, is set to be longer than that in a case where the difference is larger than the predetermined value.

12. The power supply circuit according to claim 9,
wherein the pulse width modulation signal generation circuit is configured to increase a duty cycle of the pulse width modulation signal when a value of the digital signal is negative, and
wherein the pulse width modulation signal generation circuit is configured to decrease a duty cycle of the pulse width modulation signal when a value of the digital signal is positive.
